(19) United States
(12) Patent Application Publication
(10) Pub. No.: US 2017/0329840 A1
(43) Pub. Date: Nov. 16, 2017

(54) COMPUTERIZED SYSTEM AND METHOD FOR PERFORMING A FEATURE-BASED SEARCH AND DISPLAYING AN INTERACTIVE DYNAMICALLY UPDATABLE, MULTIDIMENSIONAL USER INTERFACE THEREFROM

(71) Applicant: PEERACTIVE, INC., New York, NY (US)

(72) Inventors: James McGOWAN, Flemington, NJ (US); Nir GOLAN, New York, NY (US); Robert ARBITTIER, New York, NY (US); Joshua KAUFMAN, New York, NY (US); Nicholas ROSENTHAL, New York, NY (US); David STEIN, New York, NY (US); Alyssa BIRNBAUM, New York, NY (US); Cherian CHACKO, New York, NY (US)

(21) Appl. No.: 15/595,073

(22) Filed: May 15, 2017

Related U.S. Application Data
(60) Provisional application No. 62/337,062, filed on May 16, 2016.

(51) Int. Cl. G06F 17/30; G06F 3/0481; G06F 7/76

(52) U.S. Cl. CPC G06F 17/30643; G06F 17/30985; G06F 17/30678; G06F 3/04815; G06F 17/30056; G06F 7/76

(57) ABSTRACT

Disclosed are systems and methods for improving interactions with and between computers in a search system supported by or configured with search servers, applications or platforms. The systems interact to identify and retrieve data across platforms, which data can be used to improve the quality of results data used in processing interactions between or among processors in such systems. The disclosed systems and methods provide a novel framework for automatically analyzing items, including real-world items and digital content items, in order to determine their attributes (e.g., characteristics, features, and the like), and based on the determined attributes, generating a user interface (UI) that displays the items and their respective attributes in an interactive, dynamically updatable and searchable multidimensional display.

### CROSS-REFERENCE TO RELATED APPLICATIONS

The instant application claims priority from U.S. Provisional Patent Application No. 62/337,062, filed on May 16, 2016, entitled “Method and Apparatus for Displaying Multidimensional Data To Facilitate a Purchasing Decision,” which is incorporated herein by reference in its entirety.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to improving the performance of computerized systems, applications and/or platforms by modifying the capabilities of such systems, applications and/or platforms to perform a feature based search for content over a network, and to cause a computing device to display an interactive, dynamically updatable, multidimensional user interface (UI) inclusive of the search results.

### SUMMARY

In general, the disclosed systems and methods provide a novel framework for performing a search for items, and displaying the search results in a user interface (UI) display that has a number of n-dimensions corresponding to the attributes of the items in the results set. As discussed herein, reference to “items” herein can correspond to any real-world item or digital content or media item, or some combination thereof. For example, an item can include, but is not limited to, a diamond, automobile, electronics, tickets, travel, antiques, clothing, and the like. In another non-limiting example, items can include, image files, video files, audio files, and other types of multi-media files, digital media rights files associated with digital items (or their counterpart real-world storage mediums—for example, the digital media rights for accessing and rendering content on a flash drive), and the like.

According to some embodiments of the instant disclosure, the disclosed search performed by the systems and methods discussed herein involves automatically analyzing items, including real-world items and digital content items, in order to determine their attributes (e.g., characteristics, features, variables, values, parameters, definitions and the like—used interchangeably herein), and based on the determined attributes, generating a user interface (UI) that displays the items and their respective attributes in an interactive, dynamically updatable and searchable multidimensional display.

In some embodiments, the UI displays the items identified from the search within a multi-dimensional graphical display (as illustrated in FIG. 5A, as discussed below in more detail). The n-dimensional display of the items corresponds to the value and quantity of the attributes of the items, such that the value of each item's attributes and how they relate to other items' attributes can be visibly depicted on the UI.

Thus, the UI displays a set of items by position on the multi-dimensional display. For most current popular display technologies, this may be limited to two physical dimensions (x- and y-axes), and in virtual reality (VR) environments, a third dimension may be added (e.g., x-, y-, and z-axes). While these dimensions (particularly in the two dimensional display) are referred to as physical dimensions, in VR they can be simulated through monocular cues (e.g., such as blurring), binocular cues, modification of time-intervals, layering of the “z” value of the item, atmospheric blur, relative motion, and the like, as understood by those of skill in the art. In some alternative embodiments, the UI can be embodied as a holographic display in a similar manner as in VR.

The disclosed systems and methods provide for a more compact, accurate, cost-effective and efficient search and digital representation of items within an e-commerce (EC) environment, thereby enabling users (e.g., consumers, customers, purchasers, and the like) to efficiently and accurately search for, review and obtain (e.g., purchase) desired items (or products) via the generated UI.

The disclosed systems and methods can be employed within mobile environments as well as the standard desktop/laptop environment, and can be embodied as a system, platform, or configured as a part of a search engine, in addition to being provided and implemented as a stand-alone application, which can also be integrated within any type of web-based or mobile system, platform or device.

As evidenced by the discussion herein, the disclosed systems and methods deliver increased search accuracy and a novel functionality that enables users to manipulate the results to better refine, filter and hone-in-on their desired result. For example, upon receiving a search result graphically depicted within the UI, the user is afforded the capability to manipulate the UI in real-time (e.g., without having to reload or refresh the UI via contact with a server or resource on a network) in order to compare, contrast and filter out results that are not desired. This type of graphical display of a result set has never been performed before, nor is it readily known to those of skill in the art in the EC fields—it enables the device to more clearly, accurately and concisely display results to a user thereby increasing the likelihood that a purchase will occur.

In accordance with one or more embodiments, a method is disclosed which includes receiving a search request from a user for an item, and upon identifying a set of items that satisfy the search, automatically analyzing the items thereby determining their attributes. Such attributes are then leveraged into the generation of a dynamically updatable and searchable multidimensional UI, such that the attributes of each item in the result set are readily viewable via the n-axes of the UI display. In some embodiments, the number of axes is dependent upon the number of attributes, and in some embodiments, either in combination or alternatively, the number of axes is dependent upon the type of system, device, application or technology being utilized to view the results.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for a deep feature based retrieval of content over a network, and, as a result of such search, generate and display an interactive, dynamically updatable, multidimensional user interface (UI).

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating a client device in accordance with some embodiments of the present disclosure;

FIG. 3 is a schematic block diagram illustrating components of a system in accordance with embodiments of the present disclosure;

FIGS. 4A-4B are flowcharts illustrating steps performed in accordance with some embodiments of the present disclosure;

FIGS. 5A-5C illustrate non-limiting example embodiments of a user interface (UI) in accordance with some embodiments of the present disclosure;

FIG. 6 is a flowchart illustrating steps performed in accordance with some embodiments of the present disclosure; and

FIG. 7 is a block diagram illustrating architecture of a hardware device in accordance with one or more embodiments of the present disclosure.

### DESCRIPTION OF EMBODIMENTS

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer to alter its function, a special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, an integrated or distributed device combining various features, such as features of the forgoing devices, or the like.

A client device may vary in terms of capabilities or features. Claimed subject matter is intended to cover a wide range of potential variations. For example, a smart phone, phablet or tablet may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like.

A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, SnapChat®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

The principles described herein may be embodied in many different forms. According to embodiments of the instant disclosure, as discussed herein, the disclosed systems and methods provide a novel framework for providing search results for items (or products, used interchangeably) to users within an interactive UI display, which provides in a more robust mechanism for users to view, analyze and decide which item(s) to choose (e.g., purchase).

By way of background, conventional technologies employ a typical static pattern for allowing a user to view items and decide whether to obtain (or purchase) the item. For example, conventional systems, platforms, applications, and methodologies provide a user (e.g., consumer or purchaser) with a large list of available items that are defined by a series of attributes assigned a value. For example, a diamond is assigned a “clarity” value by a trained gemologist, or a smart phone is assigned a thickness measurement according to a prototype phone. Based on these attributes, a merchant (or owner of the item, seller or offeror of the item) assigns a market price for the item. Then, the set of items are presented to the user as a list that indicates the attributes of the item. Using that list, the user iteratively modifies the list explicitly or implicitly by sorting, eliminating items, adjusting the acceptable range of attributes, or other techniques, in a manual attempt to reduce the decision set ultimately to one item. Iteratively, over time, it is assumed that the user will converge on optimal utility. Ideally for the merchant, the user does so by adjusting the cost upward or to some other critical point where the merchant is maximizing profit.

As discussed herein, such selection methodology by a user is referred to as a “metes and bounds” approach, which captures the understanding that the user is slowly converging upon a selection decision by repeatedly constraining the considered values of the attributes until the considered set reduces to a single item/attribute. In all known technologies implementing such “metes and bounds” methodology, available items are presented as a list or grid.

The metes and bounds method suffers from two shortcomings. For one, displaying tradeoffs between items in a single list only works when there is a narrow range of options. Providing a list or even a grid of items, in comparison to other items, does little to give the user a sense of the landscape of options available to user. Secondly, the utility function is not guaranteed to converge. That is, some users may go in circles endlessly comparing items without being provided the tools to make a decision, while others need a professional seller to help. Still others do not converge on a solution that maximizes their perceived utility or maximizing the profit for the merchant.

By way of example, illustrating such shortcomings currently existing in the field, conventional systems only enable items to be offered (e.g., at a price) according to a determined number of tradeoffs. For example, when purchasing a diamond, a user one is left trying to find the best combination of its attributes—for example, clarity, cut, color and carat size for a given price. In another example, a smart phone may trade off memory, display size, bandwidth, usage limits and accessories for a given price. In yet another example, when faced with purchasing an automobile, the options are innumerable, combining financing, total cost of ownership, performance, utility and aesthetics, each of which has many dimensions of its own. In economic terms, the problem can be stated simply—one is attempting to find a maximum peak of a utility function over a multidimensional surface of perceived values. In practice, the problem is frustrating for both the user (consumer) and merchant. One has little idea of the tradeoffs between, say, diamond clarity versus color. For example, a user is faced with the decisions regarding:

“How does one determine that a small movement from yellow to clear is worth reducing the clarity from minor scratches that might not be visible to the eye, but still affect the shine of the diamond?”

“Is a princess cut a better value than a round?”

Calculating physical reflectance alone cannot solve the problem; some users will prefer a large, darker stone, while others prefer something with no visible yellow. Still others will discount clarity, which may only affect perceived quality when the diamond is freshly cleaned, while others see that as that primary value of the stone. Even if one were to have perfect knowledge of his/her own utility function, the availability of diamonds at any given dealer is sparse, so the dealer may incentivize the user to purchase from the current stock.

Additionally, such conventional systems do not determine or account for, nor do they incentivize non-linearities in pricing, as most dealers raise the price per carat based on the size. For example, the price per carat may be “x” for 1.00 to 1.24 carats, but “x+k”, “k>0”, for 1.25 to 1.49 carats. Therefore, even for a well-constrained case of a diamond purchase, one is attempting to maximize a utility function of price over four dimensions, where one dimension (cut) is categorical, and the cost is discounted for several discrete points within the space based on available inventory.

There currently exists no technological solution to such shortcomings in the field, nor is there any known mathematical technique for solving such problems deterministically. For example, performing a search via a conventional search algorithm (such as the Nelder-Mead simplex search) does not apply with non-linearities, and takes a relatively large number of evaluations to converge when they do apply. It is not surprising that users' chances of finding exactly what they desire rarely occurs.

Based on this understanding, the disclosed systems and methods provide users with a novel computerized tool for visualizing their options, and effectuating control over such items. For purposes of this disclosure, reference to an item (or items) will be made with reference to a search for a diamond. However, it should not be construed as limiting, in that, as discussed above, items can correspond to any real-world item or digital content or media item, or some combination thereof.

Thus, as discussed in the instant disclosure, the disclosed systems and methods provide a novel framework for performing a search for items that involves automatically analyzing items and determining their attributes, and based on the determined attributes, generating a user interface (UI) that displays the items and their respective attributes in an interactive, dynamically updatable and searchable manner.

By way of a non-limiting example, according to some embodiments of the disclosed UI, at the onset, a two-dimensional surface is displayed. Each axis represents a different attribute or collection of attributes from the set of possible item attributes. For purposes of this example, and discussion within this disclosure, the item is a diamond (as discussed above) and it's the y-axis corresponds to its carat size attribute, and the x-axis corresponds to its price attribute. The axes, for example, are like those in a normal graph—the far left is low price, with the price increasing toward the right. The size is smaller on the bottom, and increases as one moves upward. On the surface of the graph are multiple points that represent items available for purchase. In this example, the points are diamonds for sale, and at least a subset of which are those that a single vendor has for sale, with each having a determined size and a certain price. Note that for a single size there may be diamonds at various prices, since the diamonds will differ on other attributes, such as color and clarity.

As discussed herein, the points on the graph may be interactive graphical elements, such as, but not limited to, pictures of the diamonds. Additional information may be included on or surrounding the picture, or to the side—such as, the location of the diamond, whether it is certified, who certified the diamond, whether there are other users looking at the diamond, and the like. For aesthetic considerations, or because a seller may have a large amount of inventory, or to steer a user toward a more profitable selection, only a subset of the available, selected items may be displayed—for example, only those diamonds having attributes satisfying a threshold (e.g., those diamonds having a carat size above 1.5, and/or those diamonds having a price above $5 k).

In some embodiments, as discussed below, highlighting or selecting an individual point will potentially give more information, either located adjacent to said point, off to the side, or somewhere else on the display (e.g., in a separate window or tab of the UI). In some embodiments, as discussed below, selecting, highlighting, or otherwise interacting with an item for detailed view may cause the UI to display similar items that were otherwise suppressed due to the aforementioned reasons. In some embodiments, as discussed below, leaving a particular view of the display up for longer than a predetermined period of time may cause otherwise filtered items to be displayed.

In some embodiments, upon a selection or identification of a particular attribute(s), further filtering may occur such that only those items that have the selected attribute are displayed. For example, when a user inputs a selection that indicates that only diamonds with “I” color are to be viewed, all other items that were previously displayed prior to the selection that do not have “I” color will be automatically removed from the UI display.

In some embodiments, the UI display can be color coded for each displayed item such that specific items have dedicated colors to indicate specific attributes. For example, diamonds that are sourced from Hong Kong may be displayed in red, while diamonds from Australia may be displayed in yellow. In another example, diamonds that are colorless (i.e., E color) may displayed in white, while pink diamonds may be displayed in pink, and extremely flawed (beyond a threshold amount of inclusions) diamonds may be displayed in black.

According to some embodiments, as discussed below, the surface background may offer an additional dimension. For instance, in the above example, the background of the UI may be tinted yellow in relation to the color of a selected or requested diamond itself (which is normally a yellow tint). The tint of the background used may attempt to match the perceived color of the diamond, or may exaggerate or attenuate it. In some embodiments, the surface texture of the UI may also offer an additional dimension. For instance, the graininess of the background texture may vary according to the clarity of the diamond. Thus, it should be understood that the background of the UI can reflect a variety of attributes of the diamond a user is viewing, whether individually per attribute or according to a value of an attribute, or as a combination of attributes.

By way of another non-limiting embodiment, the axes of the UI may not represent a single attribute, but represent a combination of multiple attributes. For example, the color and clarity of a diamond may be combined into a single dimension/axis. For example, the position between two items may differ by “p” units when their color attributes differ by “c1” units, and the position of said items may differ by the same “p” units when their clarity changes by “c2” units. This is equivalent to the different attributes will be weighted differently. The assignment of such weightings (equivalences) may be determined by any known or to be known methodologies, mechanisms or technologies, such as, for example, deep learning architecture or algorithm, such as, but not limited to, deep neural networks, artificial neural networks (ANNs), convolutional neural networks (CNNs), and deep belief networks can be utilized herein. In some embodiments, such methodologies may additionally, or alternatively, employ ad-hoc means based upon expert opinion, sales experiences, a tradeoff that maximizes profit for the seller, or any other type of known or to be known technique for analyzing and weighting attributes and their variable values accordingly.

In some embodiments, such techniques, technologies and/or methodologies may involve rules that introduce significant non-linear components to the weightings, or artificial intelligence (AI) techniques, as discussed in more detail below. For example, in some embodiments, such rule-based assignment may also be made by software defined by any known or to be known mathematical techniques, such as, but not limited to, Principle Components Analysis, Factor Analysis, feature vector translation and analysis, which are dimension reducing techniques known to those with ordinary skill in the art. Such assignments can be tuned to optimize different goals, such as the aforementioned idealized utility function of the user, the profit, sell-through or revenue of the seller, or any other goal that efficiently and accurately displays/represents results matching the user's desired search request.

In some embodiments, as discussed below, a user being provided (on a display of his/her computing device) the UI is provided the capability to explore the items on the UI by manipulating the items that are displayed. This can be done, for example, by adjusting the high and low value of attributes affecting a position assignment on an axis, changing which attribute is shown on one or more axis, changing the technique used to compute position from attribute values, or any other means.

Therefore, from a user's standpoint, the user is provided a UI that provides his/her device additional functionality that allows the user's device to interact with and dynamically adjust (in some embodiments, without having to reload or request or access data from the server) the viewable items and attributes via any known or to be known manipulation techniques, including, but not limited to, touching, sliding, zooming, rotating, manipulating scroll bars, adjusting values via spinners or typing values, or any other interface technique for modifying the content presented to a user.

In some embodiments, as discussed below, for each item depicted on the UI, a position along each (dimensional) axis is computed. For example, using size and price as attributes represented by axes of a two-dimensional UI display, the value of a diamond's size is used to determine its position along the horizontal axis (x-axis of the UI), and the diamond's price is used to determine its position along the vertical axis (y-axis). In a non-limiting example embodiment, the attribute values are mapped to the position linearly, such that one unit of movement along the axis corresponds to a fixed number of units along the attribute. For example, a position change corresponding to one pixel on the display may be a fixed $400 of price change. In another non-limiting embodiment, the mapping of attribute value to position may be non-linear, such as a logarithmic relationship, as discussed above and in more detail below.

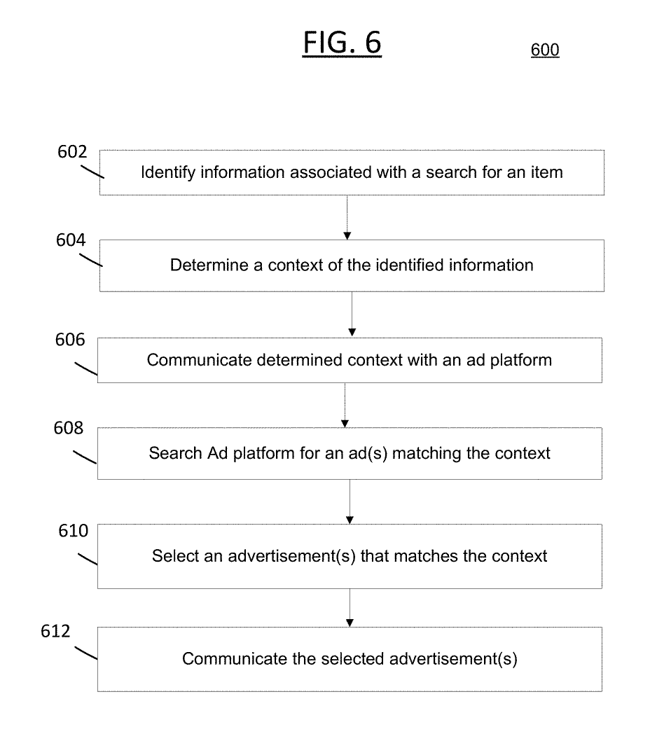

According to some embodiments, as discussed in relation to FIG. 6, information associated with a search query, item search result, a selected item, attributes of the item(s), the searching user, the merchant of the item, or some combination thereof, can be used for monetization purposes and targeted advertising when providing such search results, which can lead to an increased click-through rate (CTR) of such ads and/or an increase in the advertiser's return on investment (ROI) for serving such content provided by third parties (e.g., advertisement content provided by an advertiser, where the advertiser can be a third party advertiser, or an entity directly associated with or hosting the search systems and methods discussed herein).

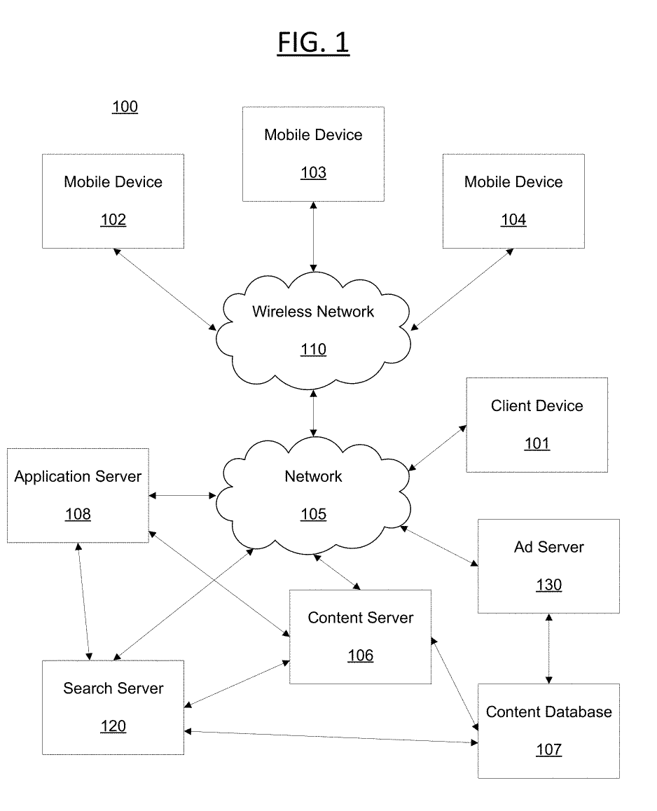

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106, application (or “App”) server 108, search server 120 and advertising (“ad”) server 130.

One embodiment of mobile devices 102-104 is described in more detail below. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, tablet computers, phablets, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier.

In some embodiments, mobile devices 102-104 may also communicate with non-mobile client devices, such as client device 101, or the like. In one embodiment, such communications may include sending and/or receiving messages, searching for and/or sharing photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Client devices 101-104 computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly. Wireless network 110 may further employ a plurality of access technologies including, but not limited to, 2nd (2G), 3rd (3G), and/or 4th (4G) generation radio access for cellular systems (and/or other advances in such technology including, for example, 5^{th} (5G) generation radio access), WLAN, Wireless Router (WR) mesh, and the like. Access technologies such as 2G, 3G, 4G, 5G and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to couple content server 106, application server 108, or the like, with other computing devices, including, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between content servers 106, application server 108, client device 101, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

According to some embodiments, the present disclosure may also be utilized within a social networking site. A social network refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, set-top boxes, SMS/MMS, email, instant messenger clients, forums, social networking sites, or the like.

In some embodiments, the disclosed networks 110 and/or 105 may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. A CDN may also enable an entity to operate or manage another's site infrastructure, in whole or in part.

The content server 106 may include a device that includes a configuration to provide content via a network to another device. A content server 106 may, for example, host a site, such as an email platform or social networking site, or a personal user site (such as a blog, vlog, online dating site, and the like). A content server 106 may also host a variety of other sites, including, but not limited to business sites, educational sites, dictionary sites, encyclopedia sites, wikis, financial sites, government sites, and the like. Devices that may operate as content server 106 include personal computers desktop computers, multiprocessor systems, microprocessor-based or programmable consumer electronics, network PCs, servers, and the like.

Content server 106 can further provide a variety of services that include, but are not limited to, search services, email services, photo services, web services, third-party services, audio services, video services, instant messaging (IM) services, SMS services, MMS services, FTP services, voice over IP (VOIP) services, or the like. Such services, for example a search engine and/or search platform, can be provided via the search server 120. Examples of content may include images, text, audio, video, or the like, which may be processed in the form of physical signals, such as electrical signals, for example, or may be stored in memory, as physical states, for example.

An ad server 130 comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers. For web portals, advertisements may be displayed on web pages or in apps resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 106, 108, 120 and 130 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In some embodiments, users are able to access services provided by servers 106, 108, 120 and/or 130. This may include in a non-limiting example, search servers, email servers, social networking services servers, SMS servers, IM servers, MMS servers, exchange servers, photo-sharing services servers, and travel services servers, via the network 105 using their various devices 101-104. In some embodiments, applications, such as a search application, can be hosted by the application server 108 (or search server 120). Thus, the application server 108 can store various types of applications and application related information including application data and user profile information (e.g., identifying and behavioral information associated with a user). It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein.

Moreover, although FIG. 1 illustrates servers 106, 108, 120 and 130 as single computing devices, respectively, the disclosure is not so limited. For example, one or more functions of servers 106, 108, 120 and/or 130 may be distributed across one or more distinct computing devices. Moreover, in one embodiment, servers 106, 108, 120 and/or 130 may be integrated into a single computing device, without departing from the scope of the present disclosure.

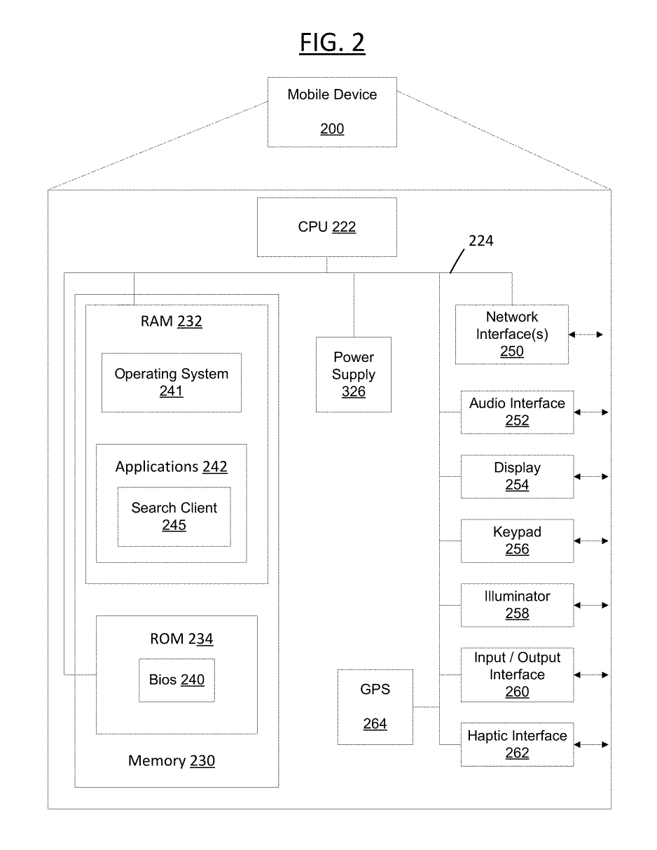

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to Client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies including, but not limited to, global system for Client communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the Client device 200 receives a communication from another user.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. It is understood that under different conditions, GPS transceiver 264 can determine a physical location within millimeters for Client device 200; and in other cases, the determined physical location may be less precise, such as within a meter or significantly greater distances. In one embodiment, however, Client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by Client device 200 to store, among other things, applications 242 and/or other data. For example, data stores may be employed to store information that describes various capabilities of Client device 200. The information may then be provided to another device based on any of a variety of events, including being sent as part of a header during a communication, sent upon request, or the like. At least a portion of the capability information may also be stored on a disk drive or other storage medium (not shown) within Client device 300.

Applications 242 may include computer executable instructions which, when executed by Client device 200, transmit, receive, and/or otherwise process audio, video, images, and enable telecommunication with another user of another client device. Other examples of application programs include calendars, browsers, contact managers, task managers, transcoders, database programs, word processing programs, security applications, spreadsheet programs, games, search programs, and so forth. Applications 242 may further include search client 245 that is configured to send, to receive, and/or to otherwise process a search query and/or search result using any known or to be known communication protocols. Although a single search client 245 is illustrated it should be clear that multiple search clients may be employed. For example, one search client may be configured to enter a search query messages, where another search client manages search results, and yet another search client is configured to manage serving advertisements, IMs, emails, and other types of known messages, or the like.

Having described the components of the general architecture employed within the disclosed systems and methods, the components' general operation with respect to the disclosed systems and methods will now be described.

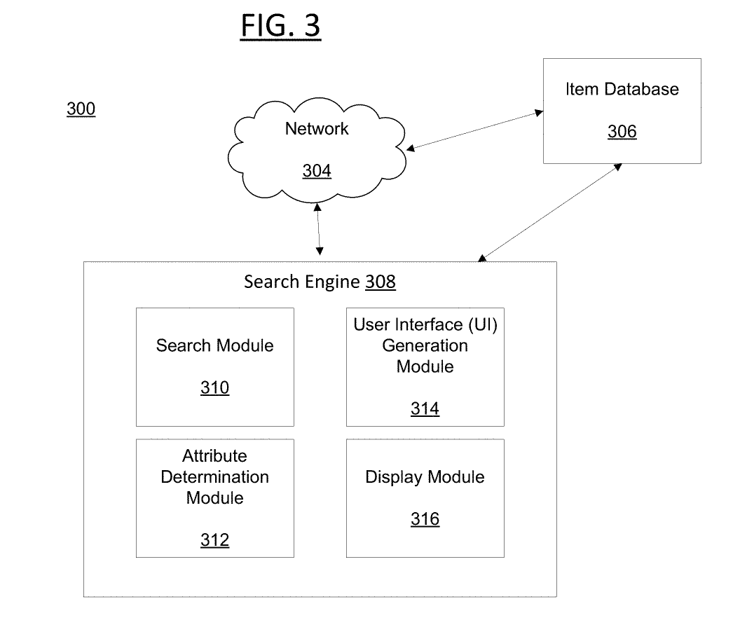

FIG. 3 is a block diagram illustrating the components of system 300 for performing the systems and methods discussed herein. FIG. 3 includes network 304, item database 306, and a search engine 308. The search engine 308 is a special purpose machine or processor and could be hosted by a web server, search server, content provider, application server, service provider, ad server, user's computing device, or any combination thereof. The search engine can be embodied as a stand-alone application downloadable to a user's device, or as a web-based (e.g., cloud-based) application that enables a user to interact with its hosting server via an interface depicted on the user's device.

The item database 306 can be any type of database or memory, and can be associated with an item server (e.g., content server 106, application server 108, or search server 120, for example). The image database 306 comprises a dataset associated with items (e.g., diamonds or other types of EC products or digital content, as discussed above). For example, for a diamond, the item database can contain a file (e.g., data and metadata) that includes the information about the diamond—including, for example, the diamonds attributes and its seller. In another example, the diamond may be depicted by a picture of a diamond having the same cut (e.g., brilliant cut), and its associated data and metadata provides the attributes and other associated information about the diamond.

As discussed above and in more detail below, the item data/metadata provides the basis for the attributes (e.g., features/descriptors) of the item. Such attributes can be directly based on the information contained in the data/metadata for an item; and in some embodiments, as discussed below, the attributes can be derived from features/descriptors of the file representing the item.

As discussed above, with reference to FIG. 1, the network 304 can be any type of network such as, but not limited to, a wireless network, a local area network (LAN), wide area network (WAN), the Internet, or a combination thereof. The network 304 facilitates connectivity of the search engine 308 and the database of stored resources 306. Indeed, as illustrated in FIG. 3, search engine 308 and database 306 can be directly connected by any known or to be known method of connecting and/or enabling communication between such devices and resources.

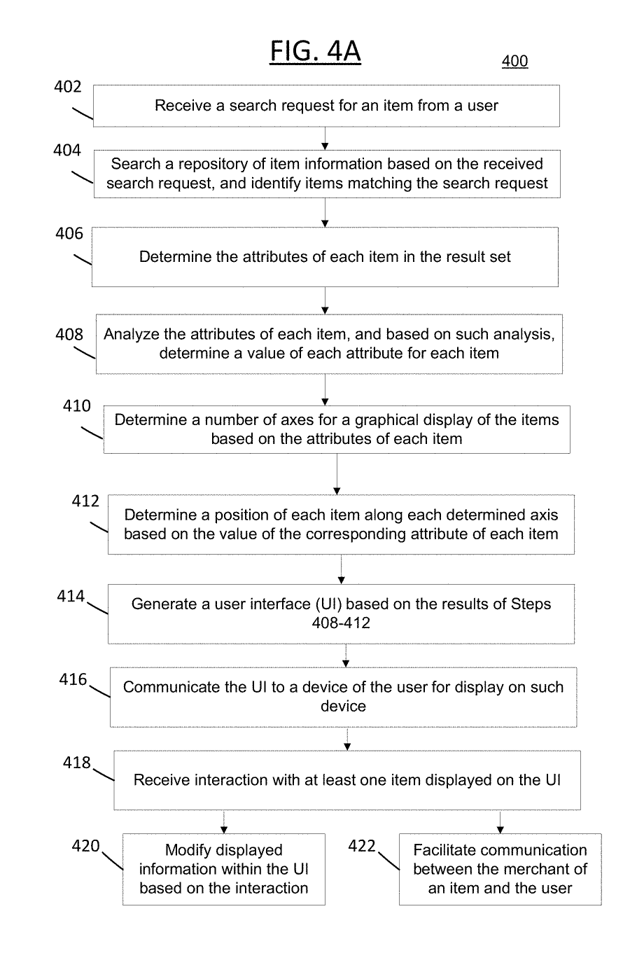

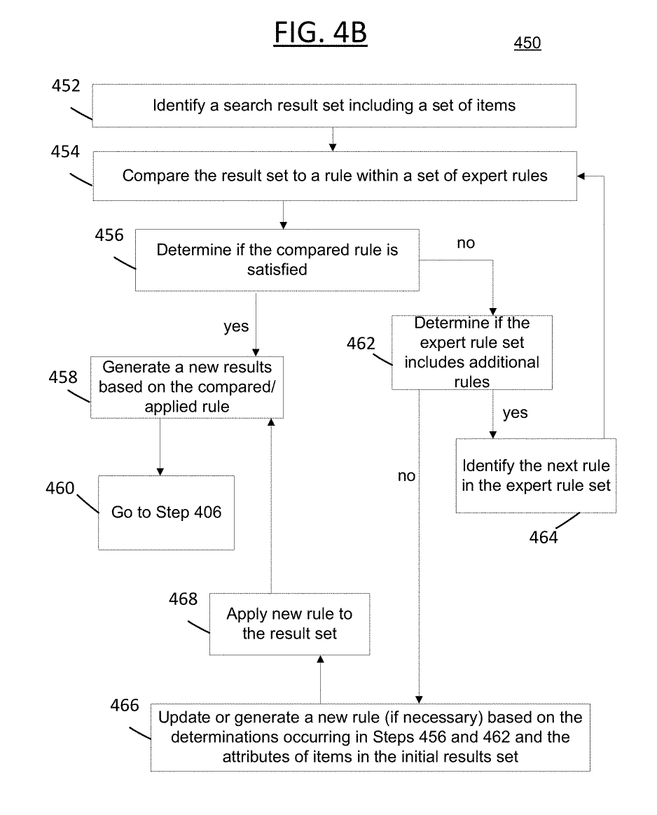

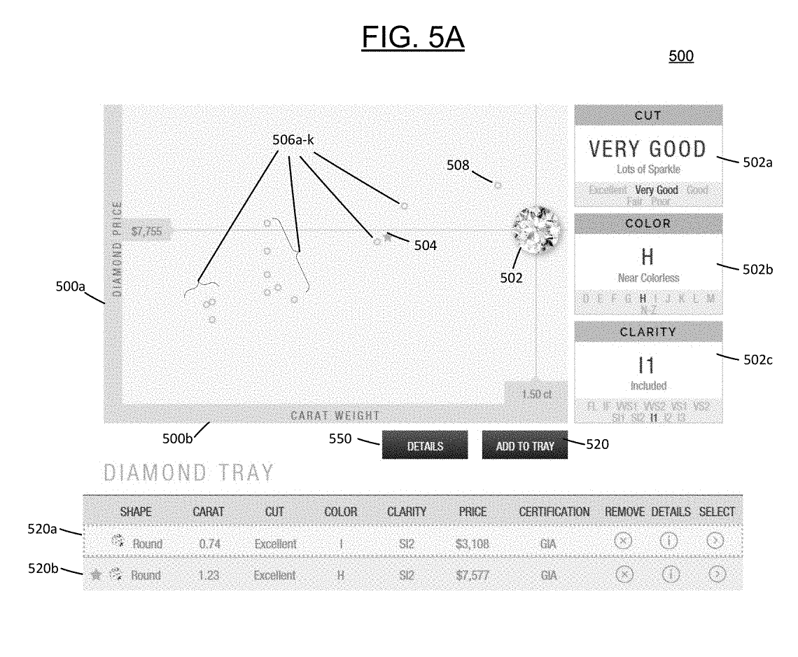

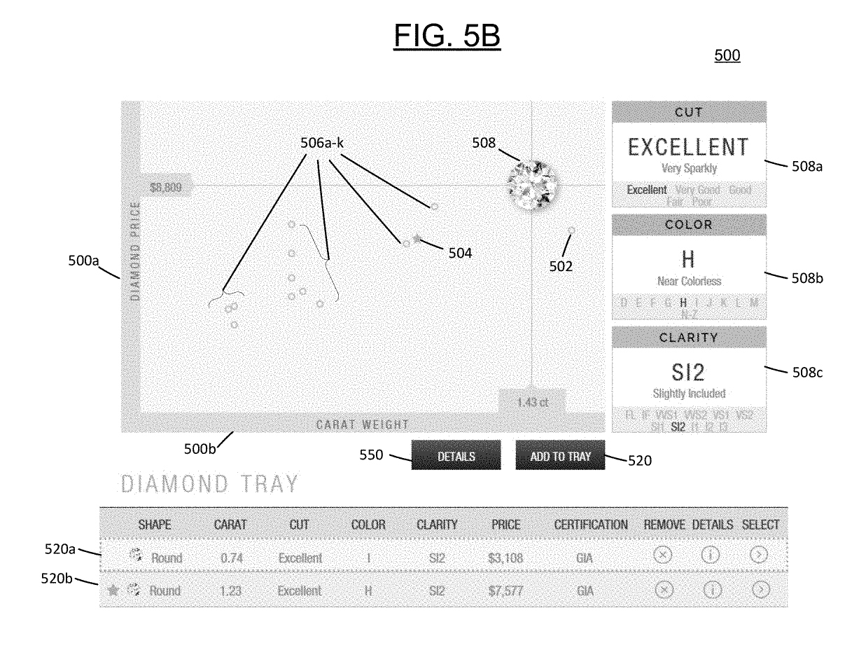

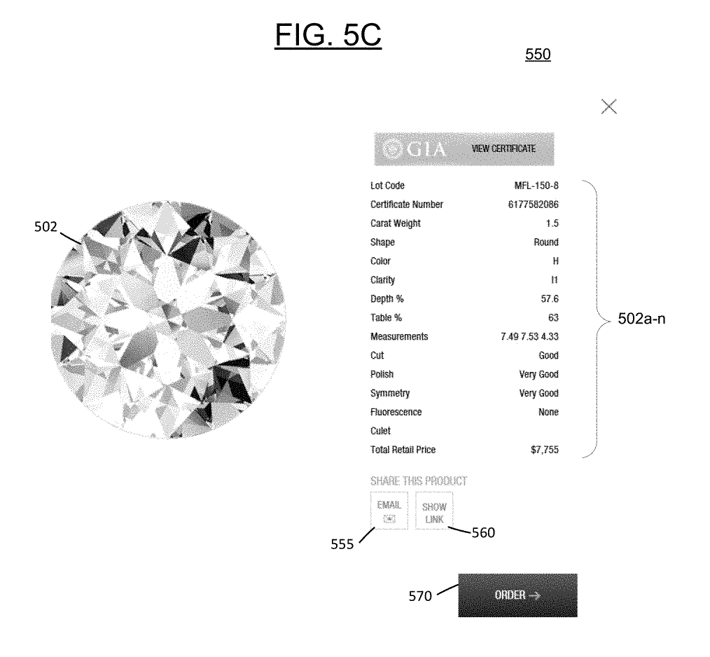

The principal processor, server, or combination of devices that comprises hardware programmed in accordance with the special purpose functions herein, referred to for convenience as search engine 308, includes a search module 310, an attribute determination module 312, a user interface (UI) generation module 314 and a display module 316.It should be understood that the engine(s) and modules discussed herein are non-exhaustive, as additional or fewer engines and/or modules may be applicable to the embodiments of the systems and methods discussed. The operations, configurations and functionalities of each module, and their role within embodiments of the present disclosure will be discussed with reference to FIG. 4-5C.

FIG. 4A is a Process 400 diagram illustrating steps performed in accordance with embodiments of the present disclosure for performing a search for items that involves automatically determining attributes and their values of identified items, and generating a user interface (UI) that displays the items and their respective attributes in an interactive, dynamically updatable and searchable manner.

As discussed above, reference to “items” will be made in reference to diamonds, and it should not be construed as limiting the instant disclosures systems and methods only to diamonds, nor to only real-world products, as one of ordinary skill in the art would understand the applicability of the disclosed functionality to digital items as well.

Steps 402-404 of Process 400 and Steps 452-468 of Process 450 (of FIG. 4B) are performed by the search module 310 of the search engine 308; Steps 406-408 are performed by the attribute determination module 312; Steps 410-414 are performed by the UI generation module 314; and Steps 416-422 are performed by the display module 316.

Process 400 begins with Step 402 where a user enters (or submits) a search request for an item (e.g., a search request for a diamond). In some embodiments, the search request comprises a character string describing an item that is entered into a search box. For example, the request can state “brilliant diamond under $5 k” or some other type of text or Boolean string query. In some embodiments, the user can be presented with a UI screen or a web page that provides the user with clickable criteria that enables the user to initially filter the results set. For example, the user can click on interface elements displayed on a web page that indicates that the user desires to see a results set for diamonds that are “princess shape”, are “brilliant cut”, are color “I”, and is between “5 k-10 k USD”. It should be understood that any type of known or to be known query can be utilized—such as, for example, voice recognition or taking a picture of a diamond and having it analyzed using image feature technology to determine the attributes of the diamond captured so that like diamonds can be discovered.

In Step 404, based on the received search request, a repository of items (e.g., database 306) is searched based on the information contained within the request. The search involves analyzing the item information in the repository in order to identify the items that correspond (at least to a threshold value) to the described item in the search request. For example, as discussed above, the search was for a diamond that had the attributes: princess, brilliant, I, between $5 k-10 k. As a result, Step 404 returns a result of the diamonds that have at least these attributes. As discussed above and in more detail below, these diamonds may have different values for other types of attributes (e.g., depth, carat, polish, symmetry and the like); however, they at least have the same attributes that were identified in the search.

Turning to Process 450, according to some embodiments, search engine 308 can utilize a set of computerized definitions and filters, referred to as “expert” rules, that are implemented as artificial intelligence software executed by the device running engine 308. As discussed above, in some embodiments, the search engine 308 can employ software comprising computer-executable rules (e.g., instructions or program logic) that apply significant non-linear weightings or filtering to the search results (of Step 404).

For example, in some embodiments, the results of Step 404 may produce a number of diamonds surpassing hundreds or thousands of results (especially for a generic search or a popular item search). As such, the disclosed systems and methods can determinatively identify such quantity, or independently and automatically apply the disclosed “expert” rules in order to narrow the result set to a subset that is more in-line with the requests and desires of a user. Thus, the expert rules can be applied upon the directive of a user, system, administrator, merchant or the search engine 308, or some combination thereof; or can be applied upon the detection that an initial search result (from Step 404) exceeds a predetermined threshold quantity; or some combination thereof. As discussed herein, the expert rules can be a preset or predefined set of criteria that identify specific attributes and their values as corresponding to the items with the best value. In some embodiments, the expert rules can be learned and/or dynamically created based on observed activity from users interactions with search results by the search engine 308, or from searches of the database 306.

As discussed herein, the expert rules can include a cascading set of filter criteria that can be set by experts in the field (e.g., gemologists), or by learned selections from users. In some embodiments, the criteria can be regionally specific—for example, certain rules can be applied for diamonds in specific parts of the world (e.g., diamonds with certain attributes are more valued in Hong Kong than they are in Australia).

By way of a non-limiting example, a cascading set of expert rules can include:

Rule 1: brilliant, color D, between $5-15 k and IF clarity.

Rule 2: brilliant, color E, between $5-15 k and IF clarity.

Rule 3: brilliant, color F, between $5-10 k and VVS1 clarity.

Therefore, as the rules are applied, if they are not satisfied, their criterion gets broader so as to ensure identifying a diamond that satisfies its criteria. It should be understood that the rules and the quantity of rules discussed above are non-limiting, as the number and type of criteria included therein can change in scope and quantity. Indeed, while the example above illustrates a narrow-to-broad approach to identify a diamond(s), the cascade can be in the reverse order (broad-to-narrow).

Process 450 begins with Step 452 where a search result set that includes a set of items (from Step 404) is identified.

In Step 454, these items are compared against a set of expert rules. As discussed above, in some embodiments, the rules can be applied individually in a cascaded manner in order to determine whether and which specific rule applies. Therefore, in some embodiments, a first rule in the set of expert rules is identified. For example, “Rule 1” from the above example. This rule and its identified attributes are compared against the items in the results set. In some embodiments, as discussed above, the comparison can be based a vector representation of the rule and the items in the results set. In Step 456, after each rule is compared/applied to the results set items, a determination is made whether it is satisfied. Such determination is based on a comparison of the attributes of each item in the set to the criteria of the rules.

If the rule is not satisfied, then Process 450 proceeds to Step 462, where a determination is made regarding whether there are other rules in the expert rules set. This determination can involve parsing the expert rule set and identifying whether there is another rule proceeding the previously applied rule. If there is another rule, in Step 464, the next rule is identified and is recursively applied in Step 454, in a similar manner as discussed above.

If Step 462 results in a determination that the expert rule set does not contain any other rules, Process 450 proceeds to Step 466. In some embodiments, if there are no rules in the expert rule set that apply to the results set, then a new rule can be generated (or an existing rule can be modified) that ensures that the results set (from Step 452) is narrowed to a satisfy a predetermined threshold that ensures only a specific number of items are returned to Process 400. Step 466. Upon this new rule being generated, it can be saved in database 306 and applied to the next result set. Step 468, which results in the generation of the new results set, as in Step 458, discussed below in more detail. In some embodiments, the generation of the new rule can be stored as part of the expert rule set such that it becomes the new last rule in the set. In some embodiments, the new rule, prior to storage and/or inclusion in the expert rule set, can be analyzed according to a set of criteria to ensure that a future application of the new rule results in a desired result. In some embodiments, such criteria can be based on a known rule set, the attributes of the initial rule set, user preferences, administrator preferences, an expert's review or preset preferences, whether the attributes of the new rule match a particular geographic area's settings or attributes, and the like, or some combination thereof.

Upon satisfaction of at least one rule in the expert rules (Step 456 or Step 466-468, as discussed above), Process 450 then proceeds with Step 458 where application of the rule to the initial results set results in a new results set being generated—one that filters out the items from the initial set that do not satisfy the applied (e.g., selected) rule. Then, in Step 460, this results set serves as the basis for Step 406 (instead of the results set from Step 404), as discussed below.

Turning back to Process 400, in Step 406, upon identifying the items that match the search query (in Step 404) (or utilizing the results set from Process 450), the items are analyzed in order to determine each of their attributes. In some embodiments, the number of attributes that are identified are based on a threshold amount of attributes, which can be based on the number of dimensions/axes the UI will have (as discussed in more detail below—for example, if the user is viewing the results on a mobile device, there may only be 2 dimensions; therefore, only 2 attributes—in another example, if a VR device is being used, then 3 dimensions/3 attributes), instructions set by the user, merchant or search engine 308, available information about the item, and the like, or some combination thereof.

As discussed above, the item database 306 comprises information about each item in the database. Therefore, for those identified items (identified from the search of Step 404 or the refined search of Process 450), Step 406 involves retrieving (or receiving) the information about each item. For example, for a diamond that was determined to match the query for a diamond having attributes: princess, brilliant, I, between $5 k-10 k—Step 406 can retrieve from the database 306 the other attributes, which as discussed above, can include: depth, carat, polish, symmetry and the like (for example, a listing of available attributes for a diamond illustrated in FIG. 5C, item 502a-n, as discussed in more detail below). In some embodiments, determination of the attributes of the items in the search result can occur when identifying them during the search, as this information can be stored in an associated manner in database 306 (e.g., in a look-up table (LUT)), and easily retrievable from said database 306.

In some embodiments, the database 306 comprises data files associated with the items, as discussed above. As such, in such embodiments, in order to determine the attributes of each item, as in Step 406 (and in some embodiments, in order to perform the search and identification of the items, as in Step 404 and Steps 452-462), the files must be parsed and analyzed with the purpose of identifying the features of each item. As such, in some embodiments, the search engine 308 can utilize “deep learning” techniques (also referred to as deep structured learning or hierarchical learning) that involve machine learning algorithms that model high-level abstractions in data by using model architectures composed of multiple non-linear transformations. Deep learning is part of a broader family of machine learning methods based on learning representations of data. A data file of an item (e.g., an image file of a diamond, for example) can be represented in many ways such as a vector of values representing the items attributes, as discussed above.

As discussed above, the search engine 300 can implement any known or to be known artificial intelligence (AI), machine learning or deep learning architecture or algorithm, such as, but not limited to, Principle Components Analysis, Factor Analysis, feature vector analysis, deep neural networks, artificial neural networks (ANNs), convolutional neural networks (CNNs), and deep belief networks can be utilized herein. According to some embodiments, deep learning methodology employs CNNs (however, it should not be construed to limit the present disclosure to only the usage of CNNs, as any known or to be known deep learning architecture or algorithm is applicable to the disclosed systems and methods discussed herein). CNNs consist of multiple layers which can include: the convolutional layer, ReLU (rectified linear unit) layer, pooling layer, dropout layer and loss layer, as understood by those of skill in the art. When used for data and/or metadata recognition and similarity (for purposes of identifying attributes of items), CNNs produce multiple tiers of deep feature collections by analyzing small portions of files (data/metadata).

It should be understood by those of skill in the art that the attributes (or features or descriptors) of items in a file being searched for and those being used as the search query can include any type of information contained in, or associated therewith, text data, image data, video data, audio data, multimedia data, metadata, file structure data, source file data, or any other known or to be known information that can be associated with, derived from or comprised within the item file.

Process 400 then turns to Step 408, where after identifying the attributes of each item, the attributes are analyzed and a value is determined for each attribute. In some embodiments, the value of the attribute corresponds to the corresponding value of the attribute. For example, if an attribute is the shape of the diamond, then the value of the diamond's shape attribute is “brilliant” if the shape is a brilliant cut. In another example, if the price of the diamond is $5,769, then the value of the price is $5,769. In yet another example, if the carat weight of the diamond is 1.23 ct, then the value of the diamond's carat weight is 1.23 ct.

In some embodiments, such information can be identified by searching the database 306 for such information, as discussed above in relation to Steps 404-406. In some embodiments, such information can be determined, derived, or otherwise identified through parsing and analyzing the item's information via the AI, deep feature learning, mathematical and/or vector analysis techniques discussed above.

In Step 410, a number of axes for a graphical display of the items and their attributes are determined. As discussed above, such determination can be based on the type of device the user is using upon requesting the search (e.g., mobile device—2 axes; and VR—3 axes), which can be provided as a type of data or metadata (e.g., identifier) within part of the initial search request. In some embodiments, the number of axes can be based on the attributes and whether each attribute satisfies a threshold. In some embodiments, the number of axes can be based on the number of attributes identified in the initial search request. In some embodiments, the number of axes can depend on the type of expert rule—for example, what parameters or attributes were identified in the expert rule that led to the identification of the items.

By way of a non-limiting example, as illustrated in FIGS. 5A-5B, UI 500 displays a set of items along x-axis 500b and y-axis 500a. These two axes correspond to a diamond's price and its carat weight, respectively.

In Step 412, a position along each axis is determined for each item based on the value of the items' corresponding attribute. For example, using the diamond selected in FIG. 5A—item 502, which has a carat weight of 1.5 ct and a price of $7,755. Therefore, as a result of these attribute values, its positioning along the x-axis (item 500b) is all the way to the right towards the end because it is a high value comparatively to the other items in the result set, and its positioning along the y-axis (item 500a) is near the middle (slightly above average) since its prices falls in that range when compared to the other diamonds in the result set.

Based on the results of Step 408-412, where the values of each items' attributes are determined, the number of axes are determined, and the position of each item along such axes based on its value is determined, respectively, the search engine 308 then generates a UI that depicts these results. Step 414. In Step 416 the UI is communicated to the requesting user's device for display on the device's display which causes the UI to be displayed on the UI device. In some embodiments, such communication thereby causes the user device to cede control of the displayed UI to the communicating server (or device hosting the search engine 308).

Turning to FIGS. 5A-5B, UI 500 illustrates non-limiting example embodiments of the generated UI discussed above in Process 400. UI 500 includes axes 500a and 500b, as discussed above. UI 500 displays the diamonds from the result set (from Step 404 or Process 450). These diamonds are represented by item 502, which according to FIG. 5A is the diamond selected by the user; and item 508, which according to FIG. 5B is the next diamond selected by the user. The diamonds also include, as depicted by the interactive elements within the UI 500, items 506a-k and item 504. Item 504 is represented by a “star” because in some embodiments, it is determined to represent the diamond in the result set that is the best value (or matches the search query with the most accuracy)—where the best value can be according to the weighting according to the expert rules, in some embodiments, as discussed above.

UI 500 further displays a diamond tray that shows “saved” diamonds from the result set (items 502, 5040, 506a-k and 508) that were selected and then added to the tray via selection of “add to tray” button 520. For example, item 504 (denoted by the “star,” as discussed above), was selected and added to the tray as item 520b. Item 520a is another diamond falling within the diamond range of items 506a-k that was selected under a similar designation.

As discussed above, in FIG. 5A, item 502 is selected by the user. Due to this selection, items 502a, 502b and 502c (e.g., embodied as UI portions of UI 500) are displayed which provide additional attributes of the diamond 502: for example, the cut 502a, color 502b and clarity 502c. Should the user desire to see all diamond 502's attributes together in one place (e.g., view the GEM certificate for diamond 502), then the user can select button 550 which results in FIG. 5C's UI display. This display shows the diamond 502 and all of its attributes 502a-n. It also enables the user to email the copy of the GEM certificate to himself or another user (button 555) or “show the link” to the copy of the GEM certificate (button 560), which can be copied and shared via any network communication protocol. Additionally, the display of FIG. 5C enables the user to place an order, via button 570, for that specific diamond.

In FIG. 5B, item 508 is selected and similar functionality as in FIG. 5A is provided for this selected diamond. Items 508a, 508b and 508c display the additional attributes of cut, color and clarity, respectively.

Turning back to Process 400, Step 418 involves the user interacting with the interactive UI generated in Step 414 and communicated to the user in Step 416 (and displayed as example UIs 500 in FIGS. 5A-5B). As discussed above, the user can interact with, click on or otherwise select any of the items in the graph displayed via the axes 500a-500b in order to obtain further information about a specific diamond, and even order the diamond, as discussed above. In some embodiments, these interactions occur dynamically via the UI 500, such that the UI is updated without having to request, reload or refresh via data from the server or hosting device of the search engine 308. Thus, the UI 500 provides an interactive, dynamic display that enables a user to navigate, in real-time, a set of search results, and easily and efficiently compare the results' attributes in order to make a decision on an item.

In Step 420, for example, should the user have initially selected item 502 (as illustrated in FIG. 5A) but then selected item 508 (as illustrated in FIG. 5B), then such interaction causes the UI 500 to be modified such that the diamond 508 is depicted as the selected display. This further causes the UI display area portions 502a-502c to automatically change to 508a-508c, as discussed above.

In Step 422, as discussed above in relation to button 570 of FIG. 5C, the user can order the diamond thereby causing the search engine 308 to facilitate communication between the merchant of the selected diamond and the user (e.g., enable the user to purchase the diamond). Further, as discussed above, the button 555 enables the user to email other users, including the merchant to inquire about further details of the selected diamond.

FIG. 6 is a work flow example 600 for serving relevant digital media content associated with or comprising advertisements (e.g., digital advertisement content) based on the information associated with a search for an item(s) (e.g., a single item or associated digital file, a plurality of files, or a collection of files, for example, a search result comprising a set of items and their associated files), as discussed above in relation to FIGS. 3-5C. Such information, referred to as “item information” for reference purposes only, can include, but is not limited to, a search query, item search result, a selected item, attributes of the item(s), the searching user, the merchant of the item, the location associated with the item, the identity of the platform and/or application being used to perform the search, and the like, and/or some combination thereof

As discussed above, reference to an “advertisement” should be understood to include, but not be limited to, digital media content that provides information provided by another user, service, third party, entity, and the like. Such digital ad content can include any type of known or to be known media renderable by a computing device, including, but not limited to, video, text, audio, images, and/or any other type of known or to be known multi-media. In some embodiments, the digital ad content can be formatted as hyperlinked multi-media content that provides deep-linking features and/or capabilities. Therefore, while the content is referred as an advertisement, it is still a digital content item that is renderable by a computing device, and such digital content item comprises digital content relaying proprietary or promotional content provided by a network associated third party.

In Step 602, item information is identified. As discussed above, the digital content item information can be based any of the information from processes outlined above with respect to FIGS. 3-5C. For purposes of this disclosure, Process 600 will refer to single identified item (e.g., a purchased item (e.g., diamond) by a user) as the basis for serving a digital advertisement(s); however, it should not be construed as limiting, as any number of items, attributes, searches, users and the like, can form such basis, without departing from the scope of the instant disclosure.

In Step 604, a context is determined based on the identified item information. This context forms a basis for serving advertisements related to the item information. In some embodiments, the context can be determined by determining a type of item (for example, which type of diamond was purchased). In some embodiments, the context can be based on a determined category which the item information of Step 602 represents. In some embodiments, the context can be based on the item's attributes.

For example, the identified item can have an attribute indicating that the diamond is valued over $10 k; therefore, the context identified in Step 604 can be related to vacations (or honeymoons) as it may be understood by the system that most users purchase such an expensive diamond upon getting engaged, which can then be leveraged in order to identify digital ad content related to deals for trips to romantic locations, as discussed herein in relation to the steps of Process 600. In some embodiments, the identification of the context from Step 604 can occur before, during and/or after the analysis detailed above with respect to Process 400 (and its sub-parts), Process 450, and/or some combination thereof.

In Step 606, the determined context is communicated (or shared) with an advertisement platform comprising an advertisement server 130 and ad database. Upon receipt of the context, the advertisement server 130 performs (e.g., is caused to perform as per instructions received from the device executing the search engine 308) a search for a relevant advertisement within the associated ad database. The search for an advertisement is based at least on the identified context.

In Step 608, the advertisement server 130 searches the ad database for a digital advertisement(s) that matches the identified context. In Step 610, an advertisement is selected (or retrieved) based on the results of Step 608. In some embodiments, the selected advertisement can be modified to conform to attributes or capabilities of the page, interface, message, platform, application or method upon which the advertisement will be displayed (e.g., the UI used to view diamond results or purchase the diamond), and/or to the application and/or device for which it will be displayed. In some embodiments, the selected advertisement is shared or communicated via the application the user is utilizing to search, view and/or render content (from the search). Step 612. In some embodiments, the selected advertisement is displayed within a portion of the interface or within an overlaying or pop-up interface associated with the search interface used to enter the query and perform the search.

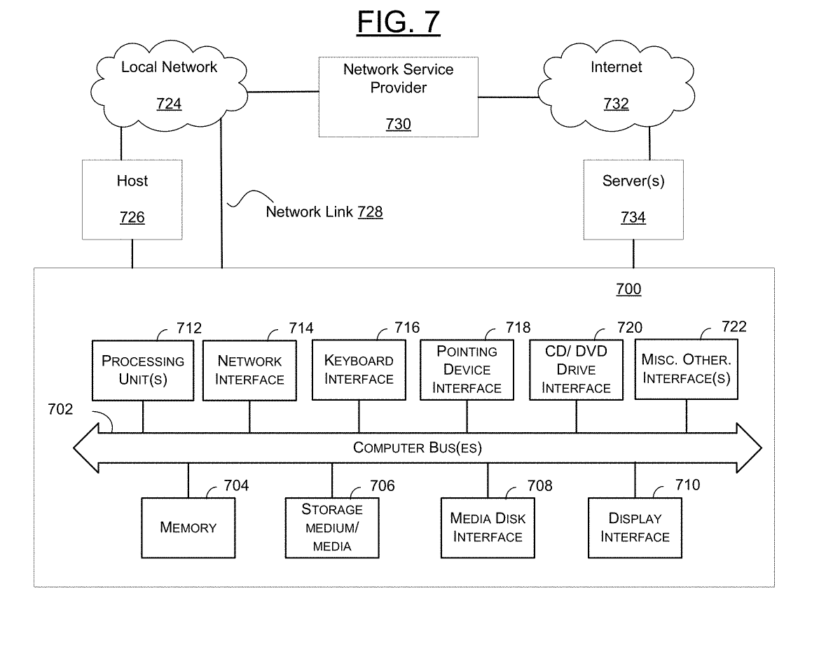

As shown in FIG. 7, internal architecture 700 of a computing device(s), computing system, computing platform and the like includes one or more processing units, processors, or processing cores, (also referred to herein as CPUs) 712, which interface with at least one computer bus 702. Also interfacing with computer bus 702 are computer-readable medium, or media, 706, network interface 714, memory 704, e.g., random access memory (RAM), run-time transient memory, read only memory (ROM), media disk drive interface 720 as an interface for a drive that can read and/or write to media including removable media such as floppy, CD-ROM, DVD, media, display interface 710 as interface for a monitor or other display device, keyboard interface 716 as interface for a keyboard, pointing device interface 718 as an interface for a mouse or other pointing device, and miscellaneous other interfaces not shown individually, such as parallel and serial port interfaces and a universal serial bus (USB) interface.

Memory 704 interfaces with computer bus 702 so as to provide information stored in memory 704 to CPU 712 during execution of software programs such as an operating system, application programs, device drivers, and software modules that comprise program code, and/or computer executable process steps, incorporating functionality described herein, e.g., one or more of process flows described herein. CPU 712 first loads computer executable process steps from storage, e.g., memory 704, computer readable storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage, e.g., medium/media 706, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 728 typically provides information communication using transmission media through one or more networks to other devices that use or process the information. For example, network link 728 may provide a connection through local network 724 to a host computer 726 or to equipment operated by a Network or Internet Service Provider (ISP) 730. ISP equipment in turn provides data communication services through the public, worldwide packet-switching communication network of networks now commonly referred to as the Internet 732.

A computer called a server host 734 connected to the Internet 732 hosts a process that provides a service in response to information received over the Internet 732. For example, server host 734 hosts a process that provides information representing video data for presentation at display 710. It is contemplated that the components of system 700 can be deployed in various configurations within other computer systems, e.g., host and server.

At least some embodiments of the present disclosure are related to the use of computer system 700 for implementing some or all of the techniques described herein. According to one embodiment, those techniques are performed by computer system 700 in response to processing unit 712 executing one or more sequences of one or more processor instructions contained in memory 704. Such instructions, also called computer instructions, software and program code, may be read into memory 704 from another computer-readable medium 706 such as storage device or network link. Execution of the sequences of instructions contained in memory 704 causes processing unit 712 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 700. Computer system 700 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 702 as it is received, or may be stored in memory 704 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, at a computing device from a user computing device over a network, a search request for an item, said search request comprising data indicating desired attributes of said item;
searching, via the computing device, a repository of information related to said item based on said search request, said search comprising analyzing said information and identifying, based on said analysis, a set of items comprising attributes at least matching the attributes identified in the search request;
analyzing, via the computing device, each item in said set in order to identify attributes of each item, said analysis comprising parsing, via the computing device, said information related to each item, and based on said parsing, identifying the attributes for each item;
analyzing, via the computing device, each attribute of each item, and based on said analysis, determining a value for each attribute;
determining, via the computing device, a number of axes of a graphical display of a user interface (UI) based at least in part on said attributes of each item in said set of items, each determined axis representing a range of values for a corresponding attribute of an item;
determining, via the computing device, a position of each item within said graphical display, said position of each item based on the determined value of each item's attributes, such that said position along said each determined axis is in accordance with said item's attribute value;
generating, via the computing device, said UI based on said determined number of axes and said position of said items, said UI generated with functionality for displaying each item at a respective position along the determined axes at said determined positions; and
communicating, via the computing device over the network, said UI to said user computing device, said communication causing said UI to be displayed on a display of the user computing device, said caused display of the UI enabling real-time interactions with each displayed item.

2. The method of claim 1, further comprising:
identifying, via the displayed UI, a real-time interaction with at least one item displayed on said UI; and
modifying the displayed UI based on said real-time interactions.

3. The method of claim 2, wherein said modification of the UI is performed dynamically such that the computing device is not required to transmit additional information to the user computing device for the UI to be modified.

4. The method of claim 2, wherein said real-time interaction comprises a selection of an item, wherein said selection causes the UI to dynamically be modified to display information related to said selected item.

5. The method of claim 2, wherein said real-time interaction comprises an identification of a specific attribute, wherein said modification comprises automatically removing the displayed items that do not have said specific attribute.

6. The method of claim 1, further comprising:
comparing said set of items to a rule, said rule comprising set of criteria that indicates at least one specified attribute; and
determining, based on said comparison, whether at least a portion of said set of items satisfies said rule.

7. The method of claim 6, further comprising:
identifying, based on said determination, a subset of said item set, said subset comprising items that satisfy said rule.

8. The method of claim 6, wherein said rule comprises a cascaded set of rules, wherein each rule in said cascaded set is ordered such that the criteria of attributes gets broader along the cascade.

9. The method of claim 8, further comprising:
recursively performing said comparison and said determination for each rule in said cascade until said determination results in said set of items being reduced to a threshold satisfying number of items; and
identifying a subset of items from said set of items based on said recursive performance, wherein said analysis of said set of items is based on said subset.

10. The method of claim 6, further comprising:
analyzing said set of items and determining, based on said analysis, a number of said items in said set of items; and
performing said comparison when said number of said items in said set of items exceeds a threshold number of items.

11. The method of claim 1, further comprising:
receiving, via the displayed UI, input indicating a request to order at least one item displayed on said UI; and
facilitating, over the network, communication between a merchant associated with the at least one item and a user of the user computing device based on said order request.

12. The method of claim 4, further comprising:
determining a context of the selected item based at least in part upon at least one of the attributes of the item;
communicating said context to an ad platform, over the network, said communication causing the ad platform to retrieve and return a digital content object comprising digital content associated with said context;
receiving said digital content object; and
communicating, over the network, said digital content object to said user computing device for display in association with the UI.

13. The method of claim 1, wherein said item comprises a real-world item.

14. The method of claim 1, wherein said item is a diamond.

15. The method of claim 1, wherein said item comprises a digital content object.

16. A non-transitory computer-readable storage medium tangibly encoded with computer-executable instructions, that when executed by a processor associated with a computing device, performs a method comprising:
receiving, at the computing device from a user computing device over a network, a search request for an item, said search request comprising data indicating desired attributes of said item;
searching, via the computing device, a repository of information related to said item based on said search request, said search comprising analyzing said information and identifying, based on said analysis, a set of items comprising attributes at least matching the attributes identified in the search request;
analyzing, via the computing device, each item in said set in order to identify attributes of each item, said analysis comprising parsing, via the computing device, said information related to each item, and based on said parsing, identifying the attributes for each item;
analyzing, via the computing device, each attribute of each item, and based on said analysis, determining a value for each attribute;
determining, via the computing device, a number of axes of a graphical display of a user interface (UI) based at least in part on said attributes of each item in said set of items, each determined axis representing a range of values for a corresponding attribute of an item;
determining, via the computing device, a position of each item within said graphical display, said position of each item based on the determined value of each item's attributes, such that said position along said each determined axis is in accordance with said item's attribute value;
generating, via the computing device, said UI based on said determined number of axes and said position of said items, said UI generated with functionality for displaying each item at a respective position along the determined axes at said determined positions; and
communicating, via the computing device over the network, said UI to said user computing device, said communication causing said UI to be displayed on a display of the user computing device, said caused display of the UI enabling real-time interactions with each displayed item.

17. The non-transitory computer-readable storage medium of claim 16, further comprising:
identifying, via the displayed UI, a real-time interaction with at least one item displayed on said UI; and
modifying the displayed UI based on said real-time interactions.

18. The non-transitory computer-readable storage medium of claim 17, wherein said real-time interaction comprises at least one of:
a selection of an item, wherein said selection causes the UI to dynamically be modified to display information related to said selected item; and
an identification of a specific attribute, wherein said modification comprises automatically removing the displayed items that do not have said specific attribute.

19. The non-transitory computer-readable storage medium of claim 16, further comprising:
comparing said set of items to a rule, said rule comprising set of criteria that indicates at least one specified attribute;
determining, based on said comparison, whether at least a portion of said set of items satisfies said rule; and
identifying, based on said determination, a subset of said item set, said subset comprising items that satisfy said rule.

20. A computing device comprising:
a processor;
a non-transitory computer-readable storage medium for tangibly storing thereon program logic for execution by the processor, the program logic comprising:
logic executed by the processor for receiving, at the computing device from a user computing device over a network, a search request for an item, said search request comprising data indicating desired attributes of said item;
logic executed by the processor for searching, via the computing device, a repository of information related to said item based on said search request, said search comprising analyzing said information and identifying, based on said analysis, a set of items comprising attributes at least matching the attributes identified in the search request;
logic executed by the processor for analyzing, via the computing device, each item in said set in order to identify attributes of each item, said analysis comprising parsing, via the computing device, said information related to each item, and based on said parsing, identifying the attributes for each item;
logic executed by the processor for analyzing, via the computing device, each attribute of each item, and based on said analysis, determining a value for each attribute;
logic executed by the processor for determining, via the computing device, a number of axes of a graphical display of a user interface (UI) based at least in part on said attributes of each item in said set of items, each determined axis representing a range of values for a corresponding attribute of an item;
logic executed by the processor for determining, via the computing device, a position of each item within said graphical display, said position of each item based on the determined value of each item's attributes, such that said position along said each determined axis is in accordance with said item's attribute value;
logic executed by the processor for generating, via the computing device, said UI based on said determined number of axes and said position of said items, said UI generated with functionality for displaying each item at a respective position along the determined axes at said determined positions; and
logic executed by the processor for communicating, via the computing device over the network, said UI to said user computing device, said communication causing said UI to be displayed on a display of the user computing device, said caused display of the UI enabling real-time interactions with each displayed item.
